(19) United States
(12) Patent Application Publication
(10) Pub. No.: US 2006/0036538 A1
(43) Pub. Date: Feb. 16, 2006

(54) Systems and methods for improved merchant processing

(76) Inventors: Wanda Griffis, Lebanon, OH (US); Anna Stawska-Szady, Gdansk (PL); Barry Wiltshire, Morely (GB); Leonard S. Kim, Cos Cob, CT (US)

Correspondence Address: Buckley, Maschoff & Talwalkar LLC, Five Elm Street, New Canaan, CT, 06840, US

(21) Appl. No.: 10/917,237

(22) Filed: Aug. 12, 2004

(51) Int. Cl. G06Q 40/00

(52) U.S. Cl. 705/39

(57) ABSTRACT

Systems and methods for merchant processing in financial transactions may, according to some embodiments, include one or more keys within a transaction file. The one or more keys may, for example, be associated with one or more parameters defining how a transaction containing a key should be settled. In some embodiments, the transaction may be split in accordance with the one or more parameters. The split transaction may then, for example, be settled with various entities.

### FIELD

Embodiments generally relate to merchant processing, and more particularly to improved merchant processing in financial transactions. Some embodiments, for example, relate to automatically splitting a financial transaction and automatically settling the split transaction with various entities.

### BACKGROUND

A number of different payment mechanisms are available to conduct a transaction. For example, payment cards (e.g., credit cards, bank cards, and private label credit cards) are often used by consumers to purchase goods and services. Transactions associated with a payment card typically involve a consumer presenting the card to a merchant, and the merchant receiving an authorization to accept (or deny) the transaction. One or more settlement systems may then conduct merchant processing whereby the consumer is billed and the merchant is reimbursed for the sale. Any third-parties (e.g., a chain affiliated with the merchant, a sponsor, a promoter, or a manufacturer) that may be associated with the transaction may then be credited or debited as appropriate, by the merchant. Where multiple third-parties are associated with the transaction, the third-parties themselves may settle with each other as is necessary. Unfortunately, such existing merchant processing and settlement processes can present difficulties.

### SUMMARY

To alleviate problems inherent in the prior art, some embodiments introduce systems, methods, and articles of manufacture for improved merchant processing.

According to some embodiments, a system, method, and article of manufacture may include receiving information associated with a financial transaction, wherein the information at least includes a key associated with the financial transaction. It may also include determining a parameter associated with the financial transaction, wherein the parameter is determined based at least in part on the key. It may further include splitting the financial transaction in accordance with the parameter. According to some embodiments, the system, method, and article of manufacture may further include settling the split financial transaction.

According to some embodiments, a system, method, and article of manufacture may include creating a parameter that defines at least one financial transaction settlement rule and associating the parameter with a financial transaction key, such that any financial transaction associated with the financial transaction key is split based at least in part on the parameter. In some embodiments, any financial transaction associated with the financial transaction key may be settled based at least in part on the parameter.

With these and other advantages and features of embodiments that will become hereinafter apparent, the embodiments described herein may be more clearly understood by reference to the following detailed description, the appended claims, and the drawings attached herein.

### BRIEF DESCRIPTION OF THE DRAWINGS

FIG. 1 is a block diagram of a payment card system.

FIG. 2 is a block diagram of a merchant settlement system.

FIG. 3 is a flow diagram of a method according to some embodiments.

FIG. 4 is a block diagram of a merchant settlement system according to some embodiments.

FIG. 5 is a schema diagram of a portion of a data storage structure according to some embodiments.

FIG. 6 is a block diagram of exemplary database tables according to some embodiments.

FIG. 7 is a schema diagram of a portion of a data storage structure according to some embodiments.

FIG. 8 is a block diagram of exemplary database tables according to some embodiments.

FIG. 9 is an exemplary flow diagram of a merchant processing method according to some embodiments.

FIG. 10 is a flow diagram of a method according to some embodiments.

FIG. 11 is a block diagram of a system according to some embodiments.

### DETAILED DESCRIPTION

Some embodiments herein are associated with “information” or “data”. As used herein, the terms “information” and “data” may be used interchangeably and may refer to any data, text, voice, video, image, message, bit, packet, pulse, tone, waveform, and/or other type or configuration of signal and/or information. Information may be or include information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encrypted, and/or otherwise packaged or manipulated in accordance with any method that is or becomes known.

Some embodiments herein are associated with a “transaction” or a “financial transaction”. As used herein, the terms “transaction” and “financial transaction” may be used interchangeably and may generally refer to any form and/or type of transaction that involves the transfer, exchange, and/or promise to transfer or exchange a form of payment. Although the exemplary transaction type described hereinafter is presented as a payment card transaction, it should be understood that any other type and/or form of transaction that is or becomes known or practicable may also or alternatively be utilized in some embodiments. Transactions in some embodiments may include, for example, but are not limited to, credit card transactions, private-label card transactions, debit card transactions, loan transactions, and/or lease transactions.

As described herein, for example, a consumer generally enters into a transaction with a merchant for the purchase of a good or service. The good or service may be associated with a ticket price and may be purchased utilizing a payment card. The merchant may be or include any entity, organization, and/or other object or device that processes the financial transaction associated with the consumer. Similarly, the payment card may be or include and/or may be substituted for any form of payment and/or payment agreement that is or becomes known. Further, the ticket price may be any metric, amount, and/or value associated with the payment required in exchange for the good or service.

Some embodiments herein are associated with a “key” or a “transaction key”. As used herein, the terms “key” and “transaction key” may be used interchangeably and may generally refer to any information that is capable of being used to identify an attribute, parameter, and/or other data associated with an object, entity, and/or item. A key may, for example, be or include any type of identifier, code, and/or metric that is or becomes known or practicable. In some embodiments, a key may be utilized to identify a parameter associated with a transaction. According to some embodiments, a key may comprise one or more other keys and/or parts or portions of other keys. Keys may, for example, be combinations of various data fields and/or other pieces of information.

Further, some embodiments herein are associated with a “parameter” or “parameters”. As used herein, the term “parameter” may refer to any type of information associated with a transaction, product, payment card, and/or other entity. For example, a parameter may include an attribute associated with a payment card transaction. In some embodiments, a parameter may, for example, define one or more settlement rules and/or other rules associated with a transaction. According to some embodiments, a parameter may be associated with a transaction via one or more keys (e.g., as described herein).

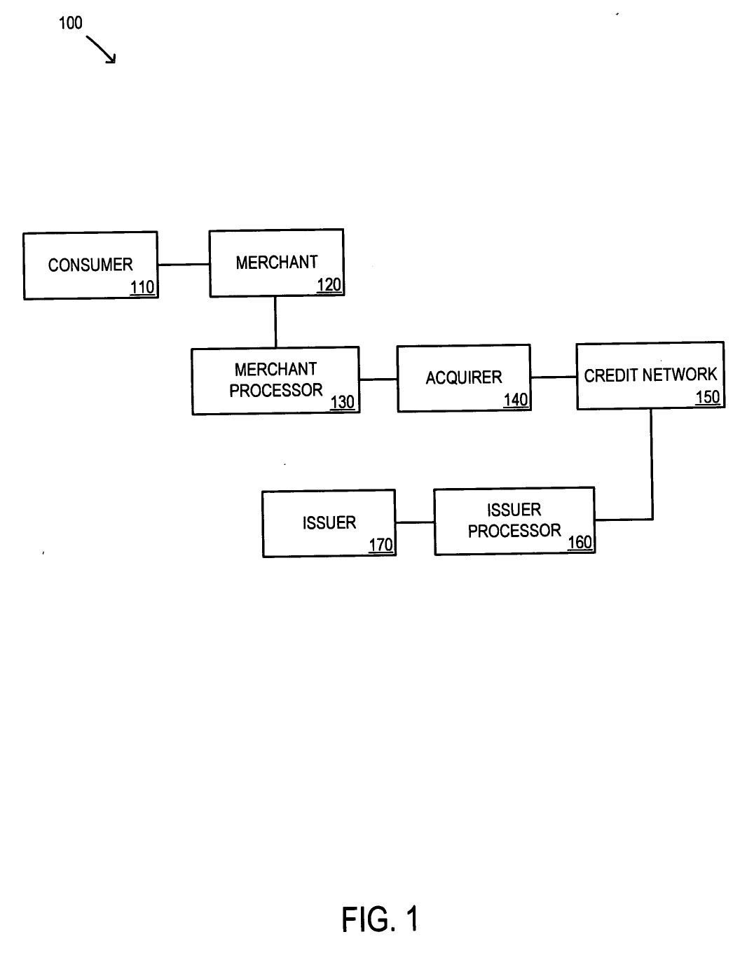

Turning to FIG. 1, a block diagram of a simplified version of a payment card system 100 is shown. The payment card system 100 may include fewer or more components than are shown in FIG. 1. The systems (such as the system 100) depicted herein are for use in explanation, but not limitation, of some embodiments. Different types, layouts, quantities, and configurations of systems, components, and/or devices may be used.

Transactions associated with a payment card may begin in the payment card system 100 with the consumer 110 presenting the payment card to a merchant 120. The payment card may be presented, for example, to make a purchase (e.g., of goods or services) at the merchant 120. The merchant 120 may then transfer information associated with the payment card (e.g., transaction information) to a merchant processor 130. The merchant processor 130 may, for example, be an entity that handles transaction processing on behalf of the merchant 120.

The merchant processor 130 may submit the payment card information and/or the transaction information to the acquirer 140, which may, for example, be a financial institution that registered the merchant 120 with the payment card system 100 (or the credit network 150). Some transactions, such as low ticket price (e.g., small value) transactions, may be authorized directly by the acquirer 140. Other transactions may be routed through the credit network 150 (e.g., such as the payment network operated by or on behalf of VISA® or MasterCard®) to the issuer processor 160.

The issuer processor 160 may, for example, be an entity that handles transaction processing on behalf of the issuer 170. The transaction may be routed by the issuer processor 160 to the issuer 170 for authorization. The issuer 170 may generally be a financial institution that issued the payment card to the consumer 110. Assuming that the requested transaction satisfies all requirements (e.g., the account has sufficient funds or available credit and other account limitations are met), a transaction authorization may, for example, be routed back to the merchant 120 via the same route that the transaction information was passed. The merchant 120 may then distribute the goods and/or services to the consumer 110.

In some payment card systems, the functionality of certain system entities may be performed by more or fewer entities than are shown in FIG. 1. For example, neither the merchant processor 130 nor the issuer processor 160 is necessary in the system 100 (e.g., the merchant 120 and/or the issuer 170 may process their own transactions). In some systems, the merchant processor 130 and the acquirer 140 may be the same entity. Similarly, the acquirer 140 and the issuer 170 may often be the same entity (e.g., the same bank).

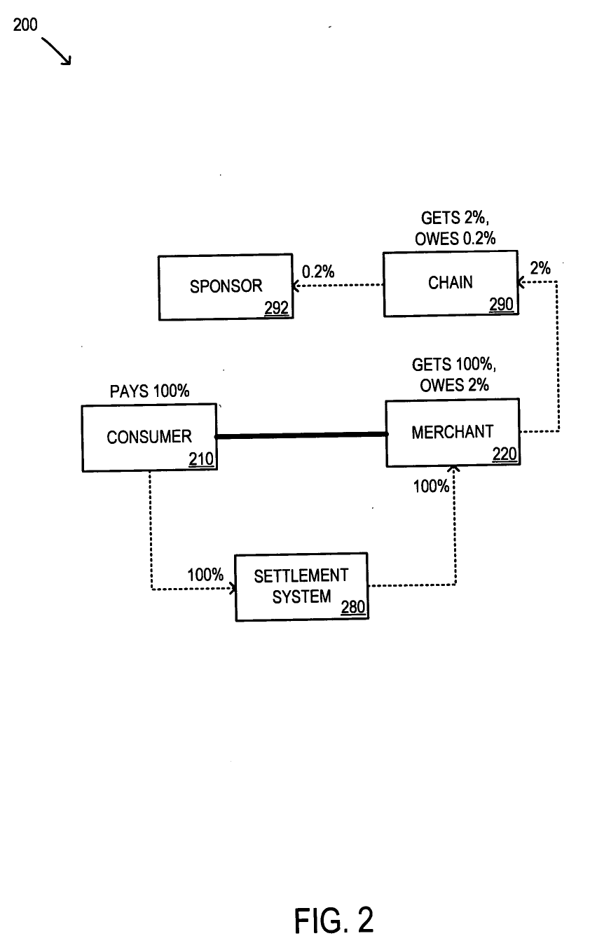

Once the transaction has been authorized and the goods and/or services have been distributed to the consumer 110, the transaction may be settled. Turning to FIG. 2, for example, a block diagram of a merchant settlement system 200 is shown. The merchant settlement system 200 may be associated with a payment card system such as the payment card system 100 described in conjunction with FIG. 1. The consumer 210 and/or the merchant 220 may, for example, be similar to the similarly-named components described in conjunction with FIG. 1.

In the merchant settlement system 200, once a transaction involving a payment card has been authorized, settlement may be initiated. The transaction may be authorized as described in conjunction with FIG. 1. In many merchant settlement systems, settlement may occur after a certain period. Transactions associated with the payment card may be aggregated over a billing period, for example, prior to commencing settlement. Settlement may then involve billing the consumer 210 for the aggregate transaction amount and reimbursing any merchants 220 for their respective sales. For ease of explanation, it will be assumed here that a single transaction has been authorized and is to be settled.

For example, a settlement system 280 may receive payment (e.g., one hundred percent of the ticket price for a purchased item) from the consumer 210. The payment may be received in response to billing the consumer 210, for example. Settlement may then involve distributing the payment (e.g., one hundred percent of the ticket price for the purchased item) to the merchant 220. In some merchant processing systems, the merchant 220 may not receive one hundred percent of the ticket price (e.g., the settlement system 280 may charge a usage fee for allowing the merchant 220 to participate in the payment card system). For simplicity, it will be assumed here that the merchant receives one hundred percent of the ticket price for the purchased item (and/or one hundred percent of the amount that the merchant is otherwise due).

In some merchant settlement systems, the settlement system 280 may be associated with and/or operated by various entities including, for example, an acquirer, an issuer, and/or a credit card network. In some situations, other parties and/or entities may be involved in the merchant and/or transaction processing and/or in the settlement of the payment card purchase. As an example, the merchant 220 may be owned and/or otherwise affiliated with a chain 290. Further, the payment card, the merchant 220, the chain 290, and/or the purchased item may be associated with another entity such as a third-party sponsor 292.

In some merchant processing systems (such as shown in FIG. 2), any or all of the third-parties may be owed certain amounts associated with the payment card transaction. The chain 290 may, for example, take two percent of the ticket price of every transaction conducted at an affiliated merchant 220 (e.g., as a franchise or corporate fee). Accordingly, once the merchant 220 is paid the ticket price by the settlement system 280, the merchant 220 may then settle with the chain 290 by distributing the requisite percentage (e.g., two percent of the ticket price) to the chain 290.

Similarly, the sponsor 292 may be owed two tenths of a percent of the ticket price for the payment card transaction. The sponsor 292 may, for example, be a sponsor of the payment card and/or of the item purchased with the payment card. The sponsor 292 may, for example, be a manufacturer, an advertiser, and/or a charity or non-profit organization. Once the chain 290 receives the two percent cut from the merchant 220, the chain 290 may then settle with the sponsor 292 by distributing the requisite two tenths of a percent to the sponsor 292. In some merchant processing systems, the merchant 220 may settle directly with both the chain 290 and the sponsor 292. In other merchant processing systems, multiple other third-parties may be associated with the transaction and may be related in various manners.

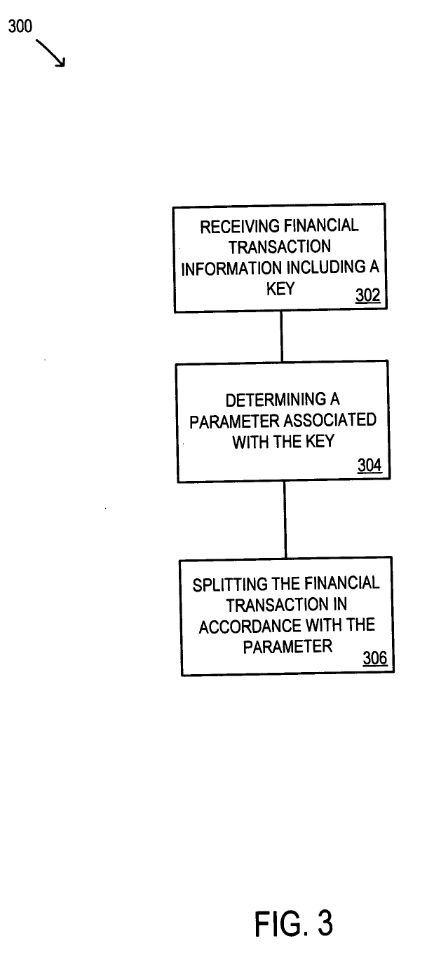

Referring now to FIG. 3, a flow diagram of a method 300 according to some embodiments is shown. In some embodiments, the method 300 may be conducted by and/or by utilizing the systems 100, 200 and/or may be otherwise associated with the systems 100, 200 described in conjunction with any of FIG. 1 and/or FIG. 2 herein. The flow diagrams herein do not necessarily imply a fixed order to the actions, and embodiments may be performed in any order that is or becomes practicable. Note that the methods described herein may be performed by hardware, software (including microcode), firmware, manual means, or any combination thereof. For example, a storage medium may store thereon instructions that when executed by a machine result in performance according to any of the embodiments described herein.

In some embodiments, the method 300 may begin at 302 by receiving transaction information including a key. For example, a transaction associated with a payment card may be initiated and/or authorized and information associated with the transaction may be sent to a settlement system (e.g., settlement system 280). The transaction information may include various metrics, fields, data, and/or other information associated with the transaction. According to some embodiments for example, the transaction information may include information relating to the name of the consumer, the ticket price of the purchased item, the date of the transaction, and/or an identifier of the merchant or store at which the transaction was conducted.

In some embodiments, the transaction information may contain one or more keys. The key may, for example, be or include one or more metrics that are used to identify various attributes associated with the transaction. The key may be a stand-alone field (e.g., a “key” field) and/or may include any practicable combination of other fields, codes, and/or data. The key may, for example, be a combination of the store identifier and an identifier associated with a particular type of credit offering or promotion (e.g., an exemplary combined-key used herein for illustrative purposes).

According to some embodiments, the method 300 may continue by determining a parameter associated with the key, at 304. The key (or one or more keys) may, for example, be associated with one or more parameters. In some embodiments, parameters may reside in a data store such as a file and/or database table and may be looked-up based on the key. Any number of parameters may be associated with any given key, and any number of keys may be associated with any given parameter. In other words, the keys and parameters may be associated via a many-to-many relationship.

Parameters may, according to some embodiments, define one or more rules associated with the transaction. For example, a parameter may define a settlement rule that describes how the transaction should be settled. In other words, the settlement rule may, according to some embodiments, identify various entities associated with the transaction and/or identify how the transaction should be settled with regard to those entities. Where third-parties are associated with the transaction, for example, the parameter may define the settlement amounts that each party should receive.

The method 300 may, according to some embodiments, continue at 306 by splitting the transaction in accordance with the parameter. Where the parameter defines a rule, for example, the transaction may be split in accordance with the rule. In some embodiments, such as where the rule includes a settlement rule, the transaction may be split based on the settlement amounts that should be distributed to any identified parties to the transaction. For example, where a third-party is to receive a percentage of the ticket price for an item purchased at a merchant, the transaction may be split into two separate sub-transactions. One sub-transaction may, for example, be associated with distributing the percentage of the ticket price to the third-party. The other sub-transaction may, in some embodiments, be associated with distributing the ticket price minus the third-party percentage, to the merchant.

In some embodiments, the method 300 may also or alternatively include other processes. For example, the transaction may be settled with any or all appropriate parties. Each of the sub-transactions (e.g., from 306) may, according to some embodiments, be settled with various parties. In some embodiments, each of the sub-transactions may be settled with different parties, for different amounts and/or percentages (e.g., of the ticket price), and/or at different times and/or frequencies.

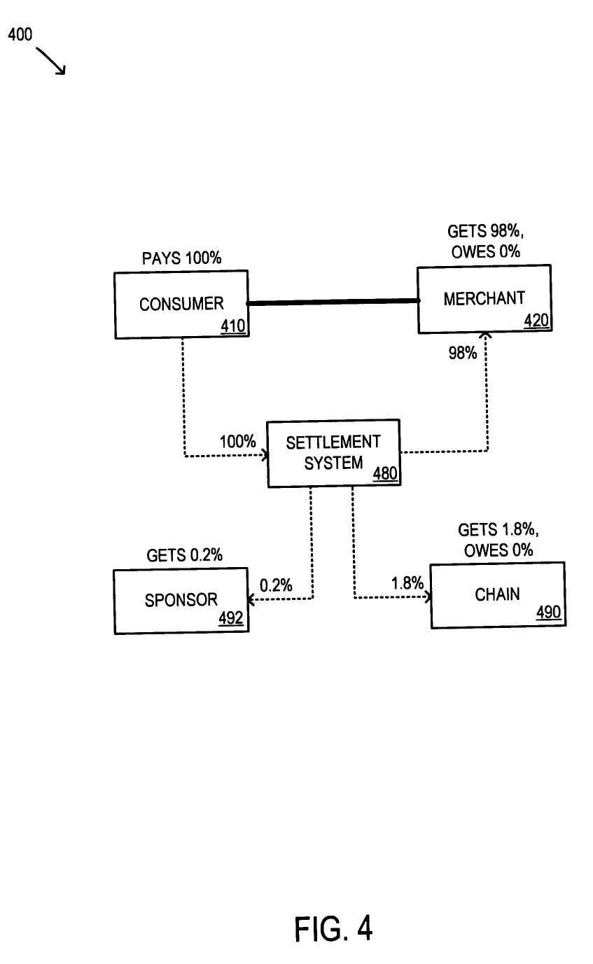

As an example, FIG. 4 shows a block diagram of a merchant settlement system 400 according to some embodiments. The system 400 may, according to some embodiments, be utilized in accordance with and/or otherwise associated with the method 300 described in conjunction with FIG. 3 herein. The system 400 may include, for example, a consumer 410, a merchant 420, a settlement system 480, a chain 490, and/or a sponsor 492. In some embodiments, the components 410, 420, 480, 490, 492 of the system 400 may be similar in configuration and/or functionality to the similarly-named components described in conjunction with any of FIG. 1 and/or FIG. 2 herein. In some embodiments, fewer or more components than are shown in FIG. 4 may be included in the system 400.

In some embodiments, the consumer 410 may present a payment card to the merchant 420 to purchase an item. Once the transaction has been authorized, the settlement system 480 may, for example, receive the ticket price of the item from the consumer 410. The settlement system 480 may, for example, bill the consumer 410 for the ticket price amount, and may then receive payment from the consumer 410. According to some embodiments, the settlement system 480 may be associated with the financial institution that issued the payment card to the consumer 410 (e.g., the issuer 170). The settlement system 480 may also or alternatively be associated with various other entities and/or parties associated with the transaction and/or system 400.

The settlement system 480 may receive, store, and/or otherwise have access to various information associated with the transaction. In some embodiments, transaction information may be transmitted to the settlement system 480 once the transaction has been authorized. The transaction information accessible by the settlement system 480 may, for example, include information identifying the consumer 410, the merchant 420, the item purchased, the ticket price of the item purchased, and/or other various types and/or pieces of information.

According to some embodiments, the transaction information may include one or more keys. The settlement system 480 may, for example, receive transaction information including a key (e.g., at 302). The key associated with the transaction may be utilized, for example, by the settlement system 480 (and/or by another device and/or entity) to identify and/or otherwise determine one or more parameters associated with the key (e.g., at 304). For example, a parameter file may include a cross-reference between potential key values and available parameters. The key may thus be utilized to look-up an associated parameter.

In some embodiments, the parameter may include and/or define various rules such as settlement rules. The parameter may define, for example, a settlement rule that describes the relationship between the merchant 420, the chain 490, and/or the sponsor 492. As shown in FIG. 4, for example, the chain 490 may take one and eight tenths of a percent of the ticket price, and the sponsor may take two tenths of a percent of the ticket price. According to some embodiments, instead of distributing the entire ticket price to the merchant 420 and thus requiring the merchant 420 to settle with the third-parties (e.g., the chain 490 and the sponsor 492), the settlement system 480 may split the transaction (e.g., at 306) to directly distribute the requisite amounts to any or all parties associated with the transaction. Utilizing the key-to-parameter relationship may therefore, according to some embodiments, allow the settlement system 480 to bypass hierarchical relationships (e.g., chain, merchant, store) to settle the transaction.

For example, the parameter identified as being associated with the transaction key may define a settlement rule that directs the transaction to be split between the merchant 420, the chain 490, and the sponsor 492. In particular, the settlement rule may state that the sponsor 492 is to receive two tenths of a percent of the ticket price, the chain 490 is to receive one and eight tenths of a percent of the ticket price, and the merchant 420 is to receive ninety-eight percent of the ticket price. In accordance with the settlement rule of the parameter, the settlement system 480 may, for example, split the single transaction for the item into multiple transactions (e.g., sub-transactions). In some embodiments, “splitting” the transaction may also or alternatively include routing the transaction and/or portions of transaction information to various parties (e.g., the chain 490 or the sponsor 492).

One of the sub-transactions may be associated with providing the chain 490 with the requisite one and eight tenths of a percent of the ticket price, and another of the sub-transactions may be associated with providing the sponsor 492 with the requisite two tenths of a percent of the ticket price. The third sub-transaction in this example may, according to some embodiments, be associated with providing the remaining ninety-eight percent of the ticket price directly to the merchant 420. In such a manner, for example, the merchant 420 is not required to process the disbursements to either the chain 490 or the sponsor 492. In other words, typical hierarchical settlement relationships and/or processes may be bypassed to provide improved merchant processing.

According to some embodiments, the parameter may define any number and/or type of rules, settlement rules, conditions, and/or other transaction attributes. In some embodiments, the parameter may define how a transaction and/or split transaction is to be settled. For example, the parameter may define and/or identify bank accounts, addresses (e.g., for mailing and/or transmitting bills or funds), commission rates, subsidy amounts, settlement frequencies, access codes, and/or other information associated with settling a transaction and/or split transaction.

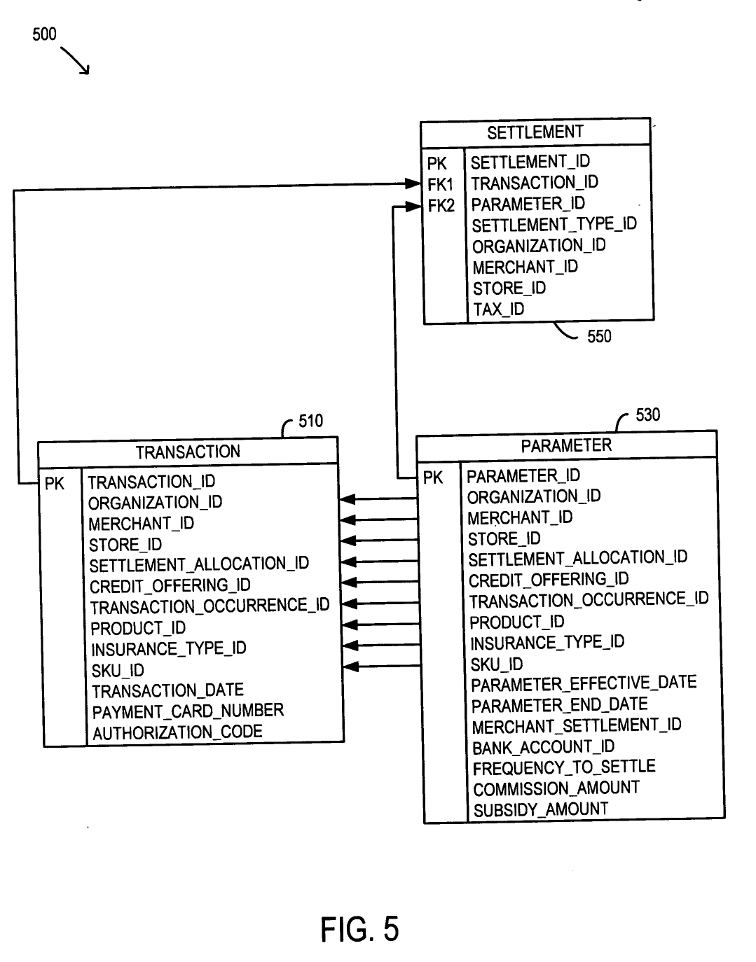

In FIG. 5, a schema diagram of an exemplary portion of a data storage structure 500 according to some embodiments is shown. The data storage structure 500 may be or include, for example, a portion of a data storage structure in which transaction information, keys, and/or parameters or parameter files are stored. According to some embodiments, the data storage structure 500 may be utilized in accordance with and/or otherwise associated with the method 300 and/or the systems 100, 200, 400 described in conjunction with FIG. 3 and/or any of FIG. 1, FIG. 2, and/or FIG. 4 herein.

As shown in FIG. 5 and as used herein generally, links between tables may be indicated with a directional arrow pointing either away from or towards a particular table. Links pointing away from a table may, according to some embodiments, generally represent Foreign Key (FK) links to other tables (e.g., the linking field in the table is a FK representing a Primary Key (PK) of another table). Links pointing toward a table may, for example, represent PK links to other tables (e.g., the linking field is the table's PK). In some embodiments, other fields in addition to or in place of a PK may be used for linking purposes. The directions and/or types of links may, according to some embodiments, be reversed, changed, and/or otherwise altered without deviating from some embodiments.

The data storage structure 500 may, according to some embodiments, include a transaction table 510, a parameter table 530, and/or a settlement table 550. In some embodiments, the transaction table 510 may contain various fields related to information associated with a transaction (as shown). The fields may include, for example, a field relating to an identifier of the transaction, an organization (e.g., a chain or franchise), a merchant (such as the merchant 120, 220, 420), a store, and/or a product type (e.g., the “transaction_id”, “organization_id”, “merchant_id”, “store_id”, and “product_id” fields, respectively).

The transaction table 510 may, according to some embodiments, also or alternatively include fields relating to credit offerings or promotions (“credit_offering_id”), insurance information (“insurance_type_id”), the type of transaction occurrence (“transaction_occurrence_id”), and/or settlement information (“settlement_allocation_id”). Other fields (some of which are shown in FIG. 5) may also or alternatively be included within the transaction table 510 as is or becomes desirable and/or practicable. In some embodiments, the transaction table 510 may include a key field used solely to store values for transaction keys (e.g., the “settlement_allocation_id” field). In some embodiments, the transaction table 510 may include fields storing information that may be otherwise utilized to identify a key associated with the transaction.

Any number and/or combination of fields within the transaction table 510 may be utilized as transaction keys. As shown in FIG. 5, for example, any of the “organization_id”, “merchant_id”, “store_id”, “settlement_allocation_id”, “credit_offering id”, “transaction_occurrence id”, “product_id”, “insurance_type_id”, and/or “sku_id” fields (including combinations thereof) may be utilized as transaction keys to link to the parameter table 530. As an example, a particular product (e.g., a particular “product_id”) sold at a particular store (e.g., a particular “store_id”) may be used as a transaction key. In some embodiments for example, the purchase of the product at the store may be associated with a particular promotion, contest, and/or discount. A key comprising the store and product identifiers may accordingly link to an appropriate parameter (e.g., in the parameter table 530) designed to implement the promotion, contest, and/or discount.

The parameter table 530 may, according to some embodiments, contain various fields related to transaction parameters. For example, the parameter table 530 may include fields defining and/or identifying one or more rules such as settlement rules. In some embodiments described herein, a user, programmer, and/or other entity may create records in the parameter table 530 in order to define how certain transactions and/or types of transactions should be processed. In addition to the many possible fields that may be used to link to the transaction table 510, the parameter table 530 may include fields such as a “merchant_settlement_id” field (e.g., identifying one or more merchants with which the transaction should be settled), a “bank_account_id” field (e.g., identifying one or more bank accounts within which settlement should take place), a “frequency_to_settle” field (e.g., defining when the transaction should be settled), and/or “commission_amount” or “subsidy_amount” fields (e.g., defining amounts associated with transaction settlement).

In some embodiments, a transaction may be split in accordance with an associated parameter as defined by the information contained within the parameter table 530. For example, a transaction having a particular key (e.g., a particular combination of a certain store and a certain product) may link to multiple records in the parameter table 530. Each record may, according to some embodiments, contain information relating to an entity (merchant, organization, etc.) with whom the transaction should be settled. Other information, such as the particular bank accounts and amounts to be settled to each account may also be defined by the fields of the parameter table 530.

Assuming the transaction links to three parameter file fields associated with different entities, for example, the transaction may be split into three separate sub-transactions, each being associated with one of the entities to which the transaction should be settled. In some embodiments, the splitting and/or settling of a transaction may be recorded and/or tracked via the settlement table 550. For example, each of the three sub-transactions may be identified by a unique “settlement_id” field in the settlement table 550. In some embodiments, three records (e.g., one for each of the sub-transactions) may be stored within the settlement table 550, each having the same value for the “transaction_id” FK linking back to the transaction table 510. In such a manner, for example, the sub-transactions may easily be identified as having been split from the same original transaction.

In some embodiments, the settlement table 550 may include other information associated with transaction settlement. The settlement table 550 may include, for example, a “parameter_id” field (e.g., identifying the parameter the transaction and/or sub-transaction was split and/or settled in accordance with), a “settlement type_id” field (e.g., identifying the type of settlement that occurred), and/or fields identifying any entities with which the transaction and/or split transaction was settled (e.g., the “organization_id”, “merchant_id”, and “store_id” fields).

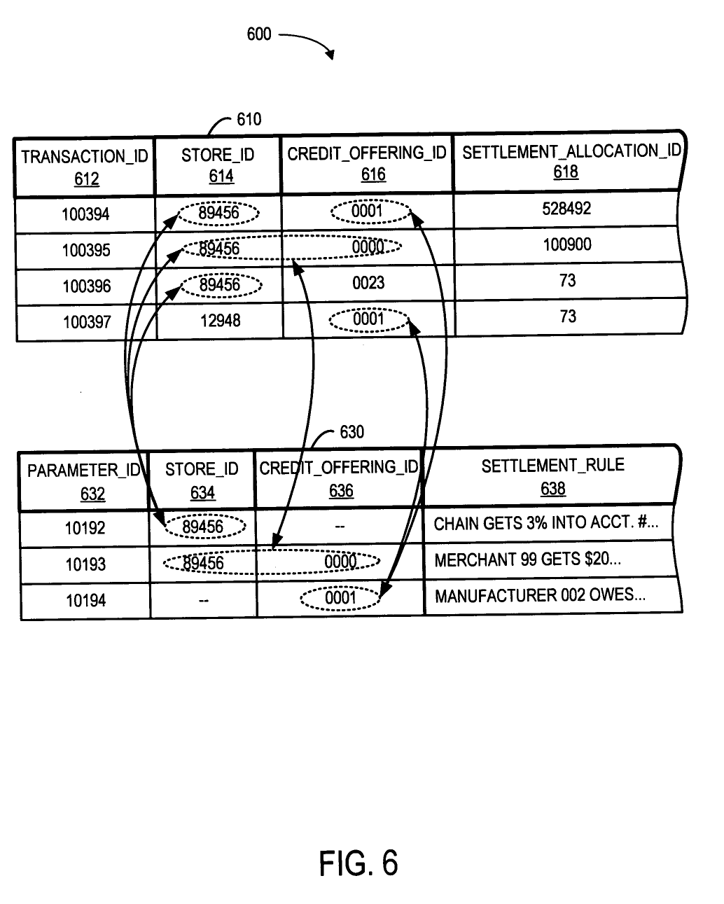

Turning now to FIG. 6, a diagram of exemplary database tables 600 according to some embodiments is shown. The exemplary data shown as being stored within the exemplary database tables 600 is provided solely for the purpose of illustration. The various database tables and/or data elements described herein are depicted for use in explanation, but not limitation, of described embodiments. Different types, layouts, quantities, and configurations of any of the database tables and/or data elements described herein may be used without deviating from the scope of some embodiments.

In some embodiments, the exemplary database tables 600 may be or include database tables stored within and/or by the settlement system 280, 480 described herein. According to some embodiments, the database tables 600 may be stored in a data storage structure similar to the data storage structure 500 described in conjunction with FIG. 5 herein. In some embodiments, fewer or more database tables and/or data fields may be included.

According to some embodiments, the database tables 600 may include a transaction table 610, and/or a parameter table 630. In some embodiments, the tables 610, 630 may be similar in content, functionality, and/or configuration to the similarly-named tables described in conjunction with FIG. 5 herein. According to some embodiments, the transaction table 610 may store information associated with transactions (e.g., transaction keys) and/or the parameter table 630 may store information associated with parameters defining rules and/or conditions relating to transactions (e.g., settlement rules).

The transaction table 610 may include, for example, a “transaction_id” field 612, a “store_id” field 614, a “credit_offering_id” field 616, and/or a “settlement_allocation_id” field 618. In some embodiments, the “transaction_id” field 612 may store an identifier and/or other indicator associated with a transaction. According to some embodiments (such as shown in FIG. 6), the “transaction_id” field 612 may be or include a unique numerical identifier for each transaction in the table (e.g., “100394” through “100397”).

In some embodiments, the “store_id” field 614 and/or the “credit_offering_id” field 616 may include information associated with a store at which the transaction took place and information associated with credit and/or other promotions or offers, respectively. The “settlement_allocation_id” field 618 may include any form and/or type of information such as information relating to transaction settlement. According to some embodiments, the “settlement_allocation_id” field 618 may be or include a key associated with a transaction. In some embodiments, any field and/or combination of fields of the transaction table 610 may be or include a key field linking the transaction table 610 to other tables.

According to some embodiments for example, a key associated with transactions may include a combination of the “store_id” field 614 and the “credit_offering id” field 616. Such a key may be represented in any manner that is or becomes practicable. The key associated with the first transaction in the transaction table 610 (e.g., “transaction_id” number “100394”) may, for example, be associated with the key of “89465-0001” (e.g., a hyphenated combination of the “store_id” field 614 and the “credit_offering_id” field 616).

Any key field and/or combination of fields defining a key in the transaction table 610 may, in some embodiments, link to one or more fields of the parameter table 630. The parameter table 630 may include, for example, a “parameter_id” field 632 identifying a particular parameter, a “store_id” field 634 (e.g., corresponding to the “store_id” field 614), a “credit_offering_id” field 636 (e.g., corresponding to the “credit_offering_id” field 616), and/or a “settlement_rule” field 638, defining an attribute, rule, and/or condition to be associated with any related transaction.

The exemplary data stored in the database tables 600 provides an example of how the transaction table 610 and the parameter table 630 may be linked according to some embodiments. The value of “89456” of the “store_id” field 614 may link to the identical (and/or otherwise associated or corresponding) values of “89456” within the “store_id” field 634 of the parameter table 630, for example. In some embodiments, more than one key and/or field may be or include a link between the transaction table 610 and the parameter table 630.

As shown in FIG. 6, for example, the first stored transaction (e.g., “transaction_id” number “100394”) may link to two parameters (e.g., “parameter_id” numbers “10192” and “10194”). The first parameter (e.g., “parameter_id” number “10192”) may, in some embodiments, be associated with the “store_id” of “89456” (e.g., a transaction key). Accordingly, any transaction involving the store identified by the “store_id” of “89456” may be associated (e.g., via the links between the transaction table 610 and the parameter table 630) with the parameter identified by the “parameter_id” of “10192”. In such a manner for example, because each of the first three stored transactions (e.g., “transaction_id” numbers “100394”, “100395”, and/or “100396”) is associated with the store “89456”, each of these transactions may be associated with the parameter “10192”.

The parameter “10192”, in some embodiments (such as shown in FIG. 6), may define a rule associated with transaction settlement. For example, the rule stored in the corresponding “settlement_rule” field 638 of the parameter “10192” record states that a chain is to receive three percent (e.g., of the ticket price). The rule may also or alternatively specify one or more particular bank accounts into which the specified amount is to be settled. According to some embodiments therefore, each and/or any of the first three transactions may be settled by distributing three percent to a bank account associated with a chain. The remaining ninety-seven percent may, for example, be distributed to the store that initiated the transaction.

According to some embodiments, the “credit_offering_id” field 616, 636 may be or include a transaction key. As shown in FIG. 6 for example, the first and last transactions (e.g., “transaction_id” numbers “100394” and “100397”) may be associated with a particular credit offering identified by the “credit_offering id” of “0001”. These transactions may link, in some embodiments, to the last parameter (e.g., “parameter_id” of “10194”) that is associated with the credit offering key of “0001”. The parameter “10194” may define, for example, a settlement rule that requires a manufacturer to pay and/or reimburse another party for a portion and/or percentage of the transaction value (e.g., the ticket price).

In some embodiments, a combination of fields may be utilized as a transaction key. As shown in relation to the second stored transaction in FIG. 6, for example, the combination of the “store_id” field 614, 634 and the “credit_offering id” field 616, 636 may comprise a key. According to some embodiments, the combination of fields may link to the parameter table 630. For example, the second transaction “100395” may link to a “store_id” of “89456” and a “credit_offering_id” of “0000”. In some embodiments, the combination may link to one or more associated parameters such as the second parameter of “10193”.

The parameter “10193” may, for example, note that a merchant involved in the transaction is to be given an extra twenty-dollars (e.g., a manufacturer's incentive).

In some embodiments, where multiple fields are utilized as transaction keys, only transactions and parameters sharing substantially similar and/or identical combined values may be associated. As shown in FIG. 6 for example, only the second transaction “100395” may be associated with the second parameter “10193”. Thus, even though the first and third transactions are associated with the same “store_id” (e.g., “89456”) as the second parameter “10193”, because they do not also share the same “credit_offering_id” (e.g., “0000”), they may not be associated with the parameter.

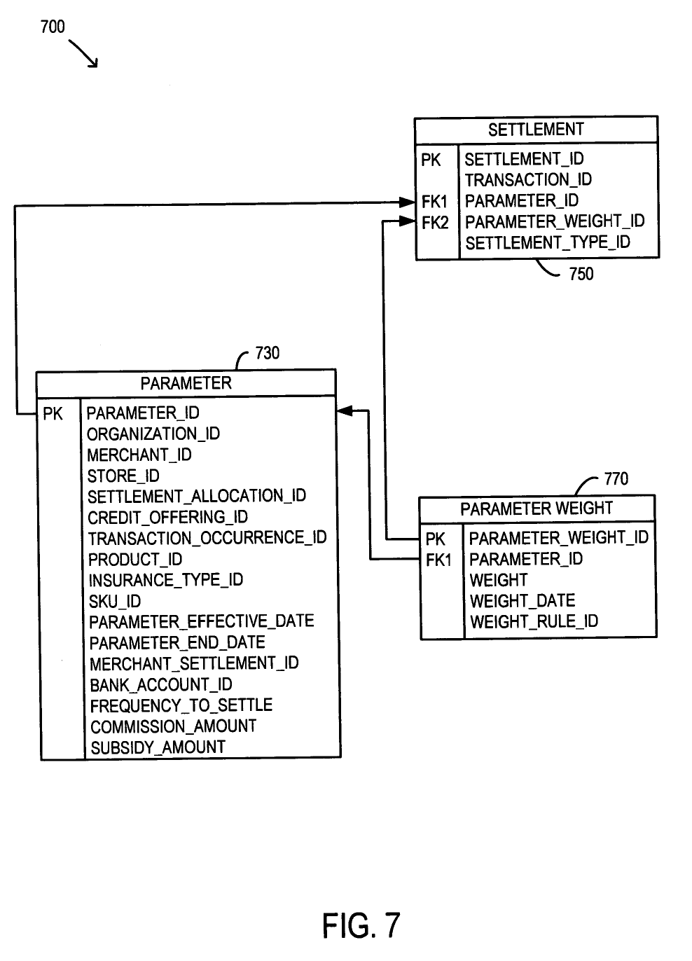

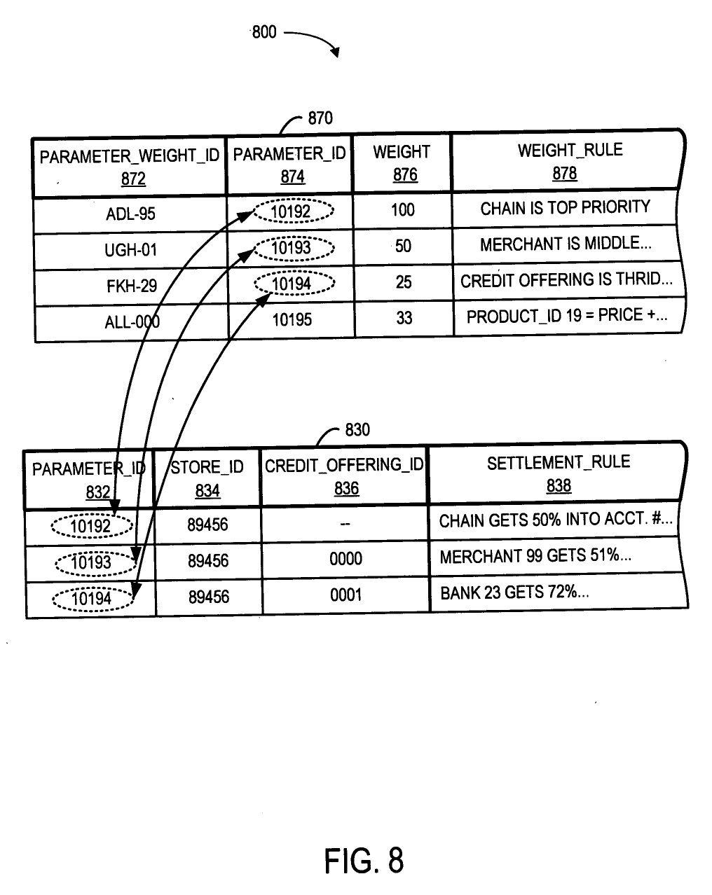

According to other embodiments, portions of combined-field keys may define an association between a transaction and a parameter. In such embodiments for example, any transaction associated with either a “store_id” or a “credit_offereing_id” shared by a parameter may be associated with that parameter. In FIG. 6, the first and third transactions may therefore, be associated with the second parameter “00193” (and/or the other parameters) because they are linked based on the same “store_id” values (e.g., “89456”). In some embodiments, a transaction may be associated with multiple parameters. One or more of the parameters may, according to some embodiments, conflict and/or otherwise not be compatible with one or more of the other associated parameters. More details relating to some such embodiments are described with respect to FIG. 7 and FIG. 8.

In FIG. 7, a schema diagram of an exemplary portion of a data storage structure 700 according to some embodiments is shown. The data storage structure 700 may be or include, for example, a portion of a data storage structure in which transaction information, keys, and/or parameters or parameter files are stored. According to some embodiments, the data storage structure 700 may be utilized in accordance with and/or otherwise associated with the method 300 and/or the systems 100, 200, 400 described in conjunction with FIG. 3 and/or any of FIG. 1, FIG. 2, and/or FIG. 4 herein. In some embodiments, the data storage structure 700 may be associated with the data storage structure 500 and/or the database tables 600 described in conjunction with FIG. 5 and FIG. 6, respectively herein.

The data storage structure 700 may, according to some embodiments, include a parameter table 730, a parameter weight table 770, and/or a settlement table 750. In some embodiments, the tables 730, 750 of the data storage structure 700 may be similar in content, configuration, and/or structure to those similarly-named tables described in conjunction with any of FIG. 5 and/or FIG. 6 herein. According to some embodiments, the parameter table 730 may link to the parameter weight table 770 (e.g., via the “parameter_id” field).

The parameter weight table 770 may, according to some embodiments, include various fields relating to parameters such as a “parameter_weight_id” field (e.g., identifying a parameter weight record), a “weight” field (e.g., specifying a weight for a parameter), and/or other fields that are shown and/or that are, or become, desirable or practicable. In some embodiments, the parameter weight table 770 may be utilized to assign, define, and/or otherwise determine a weight associated with one or more parameters. For example, when a transaction is associated with multiple parameters and some of the parameters conflict and/or are otherwise incompatible, one (or more) of the conflicting parameters may be chosen for application to the transaction.

For each of the conflicting parameters stored within the parameter table 730 there may be, for example, a corresponding record in the parameter weight table 770 defining a weight to be associated with the parameter. In some embodiments, the parameter weight table 770 may not be needed in the data storage structure 700. The parameter weight may, for example, be stored within the parameter table 730 and/or otherwise defined and/or determined. In some embodiments, when a choice is made between two conflicting parameters, the parameter with the largest and/or highest weight may be chosen for application to the transaction. According to some embodiments, the parameter and/or the parameter weight selected for application may be stored in the settlement table 750 so that the details of transaction settlement may be easily retrieved and/or examined.

Turning now to FIG. 8, a diagram of exemplary database tables 800 according to some embodiments is shown. The exemplary data shown as being stored within the exemplary database tables 800 is provided solely for the purpose of illustration. In some embodiments, the exemplary database tables 800 may be or include database tables stored within and/or by the settlement system 280, 480 described herein. According to some embodiments, the database tables 800 may be stored in a data storage structure similar to the data storage structures 500, 700 described in conjunction with any of FIG. 5 and/or FIG. 7 herein. In some embodiments, fewer or more database tables and/or data fields may be included.

According to some embodiments, the database tables 800 may include a parameter table 830, and/or a parameter weight table 870. In some embodiments, the tables 830, 870 may be similar in content, functionality, and/or configuration to the similarly-named tables described in conjunction with any of FIG. 5 and/or FIG. 7 herein. According to some embodiments, the parameter table 830 may store information associated with parameters and/or the parameter weight table 870 may store information associated with parameter weight information.

The parameter table 830 may include, for example, a “parameter_id” field 832, a “store_id” field 834, a “credit_offering_id” field 836, and/or a “settlement_rule” field 838. In some embodiments, fields 832, 834, 836, 838 may be similar in functionality and/or configuration to those similarly-named fields described in conjunction with any of FIG. 5 and/or FIG. 7 described herein. In some embodiments, the parameter weight table 870 may include a “parameter weight id” field 872, a “parameter_id” field 874, a “weight” field 876, and/or a “weight_rule” field 878. The “parameter_weight_id” field 872 may, for example, uniquely identify records defining the weighting of various parameters. The “parameter_id” field 874 may link to the “parameter_id” field 832 of the parameter table 830, according to some embodiments. The “weight” field 876 may, for example, contain a value, metric, and/or other representation of a weight to be associated with a parameter. In some embodiments, the “weight_rule” field 878 may note, define, and/or otherwise identify a rule, condition, attribute, and/or other information associated with the weight and/or weighting of the parameter.

FIG. 8 shows an example of how the parameter table 830 and the parameter weight table 870 may be linked and/or associated. According to some embodiments for example, because all three parameters are associated with the same “store_id” field 834, 874 value, if the “store_id” field 834, 874 is utilized as a key (and/or a portion of a key), then all three parameters may be associated with the same transaction. The “settlement_rule” field 838 values of the parameters do however, prevent application of more than one of the parameters to the transaction. If the first parameter (e.g., “parameter_id” of “10192”) were applied to the transaction, for example, fifty percent (e.g., of the ticket price) would be distributed to the chain. The required fifty-one percent and/or seventy-two percent disbursements to the merchant and/or bank would then not be possible (e.g., only fifty-percent would remain for disbursement).

Accordingly, one (or more) of the parameters may be chosen based upon a weight associated with the parameters. As stored in the parameter weight table 870, for example, the three parameters are associated with the weights of “100”, “50”, and “25”, respectively. The weights may represent, according to some embodiments, a hierarchy of parameter application (e.g., a parameter priority). In the example of FIG. 8, the chains get first priority, merchants get second priority, and credit offerings (e.g., associated with banks) get third priority. In some embodiments, the parameter with the highest weight may be selected for application to the transaction. The first parameter “10192” associated with the weight “100” may, for example, be applied to the transaction.

In some embodiments, any parameter not selected for application to the transaction (e.g., “losing” parameters) may be ignored with respect to the transaction. According to some embodiments, “losing” parameters may be otherwise handled and/or processed. In some embodiments, the next ranking parameter may be applied to the transaction. In FIG. 8 for example, the second parameter “10193” may be applied to the transaction as similarly as required by the parameter as is practicable. Because only fifty percent remains for distribution, the fifty percent may, for example, be distributed to the merchant “99”. Thus, the merchant “99” will receive fifty percent instead of the fifty-one percent defined by the parameter. Other methods of parameter weighting and/or application may be utilized in some embodiments.

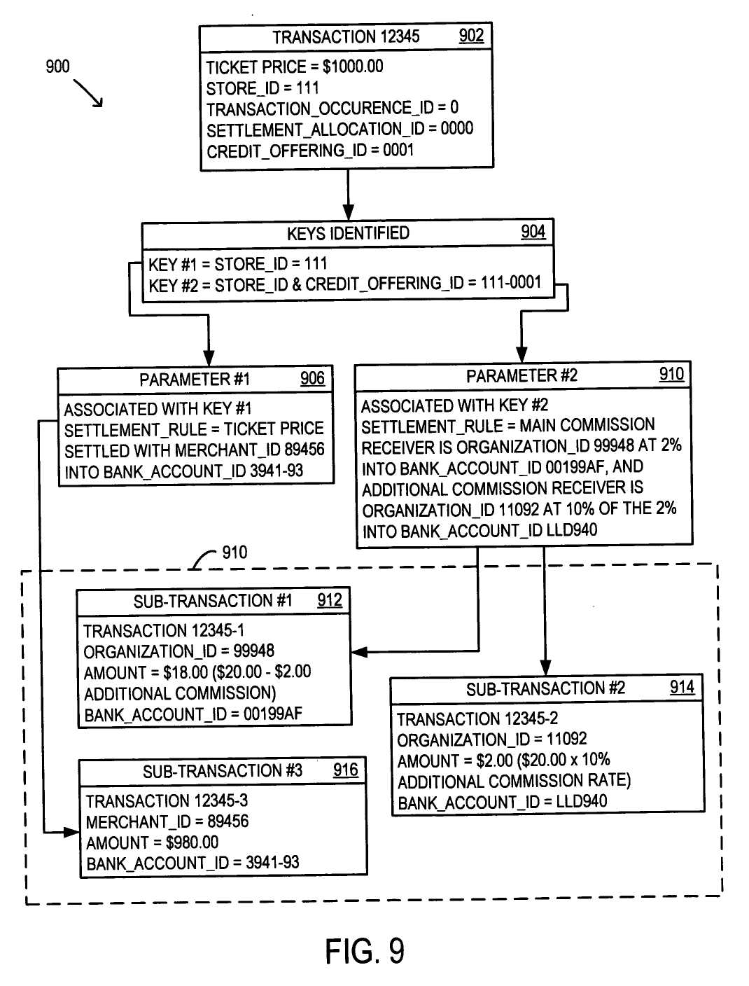

Referring now to FIG. 9, an exemplary flow diagram of a merchant processing method 900 according to some embodiments is shown. The merchant processing method 900 may, for example, be associated with the method 300, the systems 100, 200, 400, the data storage structures 500, 700, and/or the database tables 600, 800 described in conjunction with any of FIG. 1, FIG. 2, FIG. 3, FIG. 4, FIG. 5, FIG. 6, FIG. 7, and/or FIG. 8 herein. In some embodiments, fewer or more processes and/or procedures may be included in the merchant processing method 900 than are shown in the example of FIG. 9.

The merchant processing method 900 may begin, according to some embodiments, by receiving a transaction (e.g., transaction “12345”) at 902. The transaction may include, for example, a ticket price (e.g., one thousand dollars), a “store_id” (e.g., “111”), a “transaction_occurrence_id” (e.g., zero), a “settlement_allocation_id” (e.g., “0000”), and/or a “credit_offering_id” (e.g., “0001”). According to some embodiments, the transaction may be associated with a payment card and/or a cardholder. In some embodiments, the transaction may include one or more keys (e.g., as described herein).

At 904, for example, the one or more keys associated with the transaction may be identified. In the example of FIG. 9, two keys (e.g., “Key #1” and “Key #2”) are identified. The first key is associated with the “store_id” field of the transaction and is defined as being equivalent to the “store_id” value of “111”. The second key is a combination key that includes both values “111” and “0001” from the “store_id” and “credit_offereing_id” fields, respectively. In some embodiments, fewer or more keys having any configuration that is or becomes known or practicable may be utilized in association with the transaction.

The merchant processing method 900 may continue, for example, at 906 to process the transaction in accordance with the first key. The first key may, for example, be utilized to identify and/or otherwise determine a first parameter (e.g., “Parameter #1”) associated with the first key. The first parameter may, according to some embodiments, define a “settlement_rule” such as: the ticket price is to be settled with a specific merchant (e.g., merchant “89456”) into a specific bank account (e.g., bank account “3941-93”).

According to some embodiments, the method 900 may also or alternatively determine one or more parameters associated with the second key at 908. The second parameter identified in FIG. 9 may, for example, define a “settlement_rule” such as: a main commission of two percent is to go to a main receiver (e.g., organization “99948”) via a particular bank account (e.g., bank account “00199AF”), and an additional commission of ten percent of the main commission is to go to an additional receiver (e.g., organization “11092”) via a particular bank account (e.g., bank account “LLD940”).

In some embodiments, the method 900 may continue at 910 to split the transaction in accordance with any associated parameters. The transaction may, for example, be split into three sub-transactions (e.g., sub-transactions “12345-1”, “12345-2”, and “12345-3”) in accordance with both the first and second parameters. The first sub-transaction may be settled at 912 in some embodiments. The first sub-transaction may, for example, provide the two percent main commission, minus the additional commission, to the main receiver. The second sub-transaction may provide the additional commission of ten percent of the main commission to the additional receiver, at 914. In some embodiments, the third sub-transaction, at 916, may be settled to provide the remaining ticket price to the designated merchant (e.g., nine hundred and eighty dollars into bank account number “3941-93”).

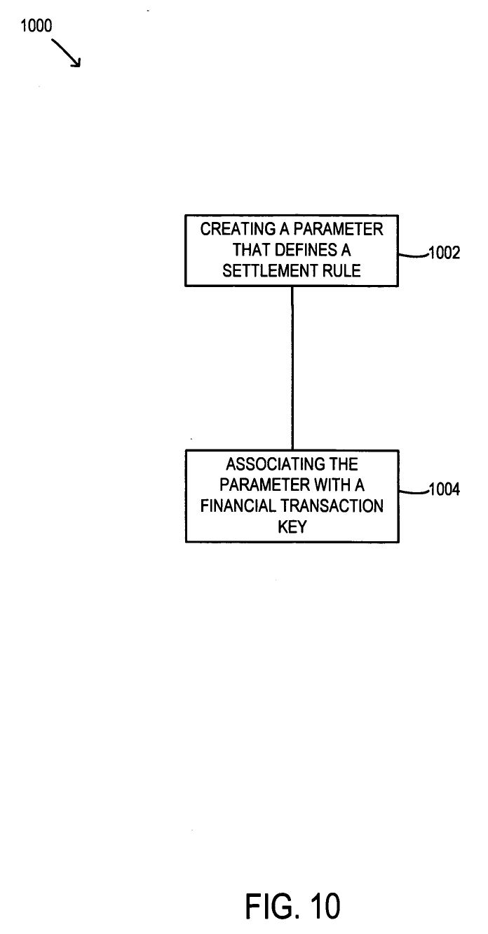

Referring now to FIG. 10, a flow diagram of a method 1000 according to some embodiments is shown. In some embodiments, the method 1000 may be conducted by and/or by utilizing the systems 100, 200, 400 and/or may be otherwise associated with the systems 100, 200, 400 described in conjunction with any of FIG. 1, FIG. 2, and/or FIG. 4 herein.

In some embodiments, the method 1000 may begin at 1002 by creating a parameter that defines a settlement rule. The parameter may, for example, be a parameter as described herein that is associated via a key to a transaction. In some embodiments, the parameter may define one or more rules regarding how the transaction should be settled. According to some embodiments (such as with respect to the second parameter from FIG. 9), the parameter may identify multiple parties with whom the transaction should be settled. In some embodiments, a programmer, financial employee, and/or other user may define the parameter. The parameter may, for example, be included in a parameter file created to facilitate the management of merchant processing.

In some embodiments, the method 1000 may continue by associating the parameter with a transaction key, at 1004. The parameter and/or parameter file may, for example, be stored (e.g., in a database) and linked to one or more transaction keys. According to some embodiments, any transaction associated with the transaction key may be split in accordance with the parameter. In some embodiments, the transaction may be otherwise managed and/or processed in accordance with the parameter.

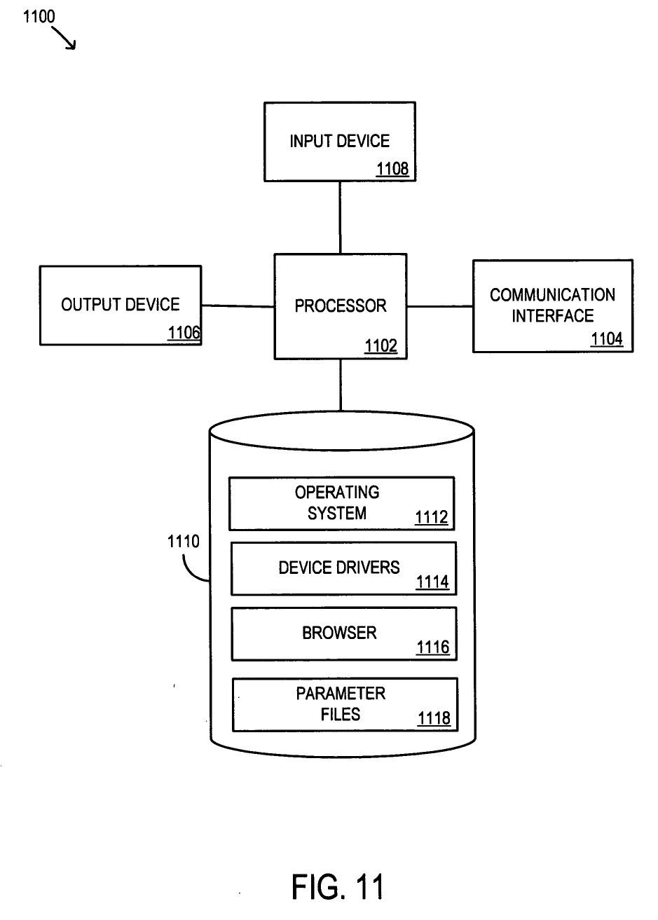

Referring now to FIG. 11, a block diagram of a system 1100 according to some embodiments is shown. In some embodiments, the system 1100 may be utilized, for example, to carry out any of the methods 300, 900, 1000 described herein. The system 1100 may also or alternatively be associated with any of the systems 100, 200, 400 described herein. According to some embodiments, different types, layouts, quantities, and configurations of systems may be used.

In some embodiments, the system 1100 may be or include a computer such as a computer server. According to some embodiments, the system 1100 may be a settlement system such as the settlement systems 280, 480 described herein. In some embodiments, the system 1100 may be a computer workstation utilized to create and/or define parameters and/or parameter files. The system 1100 may include one or more processors 1102, which may be any type or configuration of processor, microprocessor, and/or micro-engine that is or becomes known or available. In some embodiments, the system 1100 may also or alternatively include one or more communication interfaces 1104, an output device 1106, an input device 1108, and/or a memory device 1110, all and/or any of which may be in communication with the processor 1102.

The communication interface 1104 may be or include any type and/or configuration of communication device that is or becomes known or available. In some embodiments, the communication device 1104 may allow the system 1100 (and/or the processor 1102) to communicate with, for example, a settlement system 280, 480, a merchant, a consumer, and/or one or more third-parties. The output device 1106 and the input device 1108 may be or include one or more conventional devices such as displays, printers, keyboards, a mouse, a trackball, etc. The devices 1106, 1108 may be utilized, for example, by an operator and/or system user to create, edit, and/or manage parameter files and/or transaction keys.

The memory device 1110 may be or include, according to some embodiments, one or more magnetic storage devices, such as hard disks, one or more optical storage devices, and/or solid state storage. The memory device 1110 may store, for example, an operating system 1114, device drivers 1116 (e.g., to interface with the input device 1108 and/or the output device 1106), applications, programs, procedures, and/or modules. In some embodiments, the memory device 1110 may include a browser 1116. The browser 1116 may, for example, be a web browser and/or other program utilized by a user to interface with systems operating in accordance with some embodiments. The browser 1116 may, for example, facilitate creation, editing, and/or management of parameter files and/or other transaction information (e.g., transaction keys).

According to some embodiments, the memory device 1110 may also or alternatively include parameter files 1118. In the case that the system 1100 is a settlement system, for example, the parameter files 1118 may be utilized by the system 1100 to associate transaction keys with parameters. In some embodiments, the parameter files 1118 may be similar in configuration and/or composition to the data storage structures 500, 700 and/or database tables 600, 800 described herein. In some embodiments, the system 1100 may otherwise be utilized to conduct, facilitate, and/or perform various embodiments described herein.

Although the examples described herein have generally been directed to the purchase of a good or service using a payment card, other transaction types may be practiced in accordance with some embodiments. The transaction may, for example, be a loan payment made by a consumer to a lending institution (e.g., a bank or other financial institution). The key-parameter usage described herein may, in some embodiments, be utilized to automatically split the loan payment between the lending institution and any other third-party to the loan (an underwriter, a mortgage insurance provider, a taxing authority, an insurance provider, a sponsor, etc.).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method, comprising:
receiving information associated with a financial transaction, wherein the information at least includes a key associated with the financial transaction;
determining a parameter associated with the financial transaction, wherein the parameter is determined based at least in part on the key; and
splitting the financial transaction in accordance with the parameter.

2. The method of claim 1, further comprising:
settling the split financial transaction.

3. The method of claim 2, wherein the split financial transaction is settled based at least in part on the parameter.

4. The method of claim 3, wherein the parameter defines a settlement frequency.

5. The method of claim 2, further comprising:
associating a settlement type identifier with the split financial transaction.

6. The method of claim 1, wherein the splitting comprises:
splitting the financial transaction into a first financial transaction and a second financial transaction.

7. The method of claim 6, further comprising:
settling the first financial transaction with a first entity; and
settling the second financial transaction with a second entity.

8. The method of claim 1, wherein the key includes at least one of a store identifier, a merchant identifier, a credit offering identifier, a settlement allocation identifier, an insurance type identifier, a product type identifier, a financial transaction occurrence identifier, or a stock-keeping unit identifier.

9. The method of claim 1, wherein the parameter includes at least one of a ticket price parameter, a subsidy parameter, a commission parameter, an insurance parameter, an extra commission parameter, or a promotional parameter.

10. The method of claim 1, wherein the parameter defines a settlement rule.

11. The method of claim 10, wherein the settlement rule defines at least one of: one or more entities, one or more amounts, one or more percentages, or one or more bank accounts.

12. The method of claim 1, wherein the key includes a plurality of keys nd the parameter includes a plurality of parameters, and wherein a parameter from the plurality of parameters is associated with each of the plurality of keys, further comprising:
weighting at least one of the plurality of parameters.

13. The method of claim 12, wherein the at least one parameter is weighted based at least in part on the key associated with the at least one parameter.

14. The method of claim 12, wherein at least a first and a second parameter of the plurality of parameters are weighted and the splitting of the financial transaction comprises:
determining whether a first settlement rule associated with the first parameter conflicts with a second settlement rule associated with the second parameter; and
selecting, in the case that the first and second settlement rules conflict, at least one of the first or second settlement rules based at least in part on the weights of the first and second parameters.

15. The method of claim 1, wherein the financial transaction is a payment card transaction.

16. The method of claim 15, wherein the payment card transaction is a credit card transaction.

17. The method of claim 1, wherein the financial transaction is a lease.

18. The method of claim 1, wherein the financial transaction is a loan.

19. A system, comprising:
a processor; and
a storage medium having stored therein instructions that when executed by a machine result in:
receiving information associated with a financial transaction, wherein the information at least includes a key associated with the financial transaction;
determining a parameter associated with the financial transaction, wherein the parameter is determined based at least in part on the key; and
splitting the financial transaction in accordance with the parameter.

20. The system of claim 19, wherein the instructions, when executed by a machine, further result in:
settling the split financial transaction.

21. The system of claim 20, wherein the split financial transaction is settled based at least in part on the parameter.

22. An article of manufacture, comprising:
a storage medium having stored thereon programming code, comprising:
code to receive information associated with a financial transaction, wherein the information at least includes a key associated with the financial transaction;
code to determine a parameter associated with the financial transaction, wherein the parameter is determined based at least in part on the key; and
code to split the financial transaction in accordance with the parameter.

23. The article of manufacture of claim 22, wherein the programming code further comprises:
code to settle the split financial transaction.

24. The article of manufacture of claim 23, wherein the split financial transaction is settled based at least in part on the parameter.

25. A system, comprising:
means for receiving information associated with a financial transaction, wherein the information at least includes a key associated with the financial transaction;
means for determining a parameter associated with the financial transaction, wherein the parameter is determined based at least in part on the key; and
means for splitting the financial transaction in accordance with the parameter.

26. The system of claim 25, further comprising:
means for settling the split financial transaction.

27. The system of claim 26, wherein the split financial transaction is settled based at least in part on the parameter.

28. A method, comprising:
creating a parameter that defines at least one financial transaction settlement rule; and
associating the parameter with a financial transaction key such that any financial transaction associated with the financial transaction key is split based at least in part on the parameter.

29. The method of claim 28, wherein any financial transaction associated with the financial transaction key is settled based at least in part on the parameter.

30. The method of claim 29, wherein the parameter defines a settlement frequency.

31. The method of claim 28, wherein the parameter includes at least one of a ticket price parameter, a subsidy parameter, a commission parameter, an insurance parameter, an extra commission parameter, or a promotional parameter.

32. The method of claim 28, wherein the key includes at least one of a store identifier, a merchant identifier, a credit offering identifier, a settlement allocation identifier, an insurance type identifier, a product type identifier, a financial transaction occurrence identifier, or a stock-keeping unit identifier.

33. The method of claim 28, wherein the parameter includes a plurality of parameters, each of the plurality of parameters is associated with one of a plurality of financial transaction keys, and any financial transaction that is associated with more than one of the plurality of financial transaction keys is split based at least in part on one or more of the plurality of parameters.

34. The method of claim 33, wherein the one or more of the plurality of parameters utilized to split the financial transaction are selected based at least in part on a weight associated with the one or more parameters.
